(19) United States
(12) Patent Application Publication
(10) Pub. No.: US 2026/0258925 A1
(43) Pub. Date: Sep. 3, 2026

(54) LIGHTING DEVICE FOR A VEHICLE, COMPRISING AN OUPUT LENS AND AN INTERMEDIATE SCREEN

(71) Applicant: VALEO VISION, Bobigny (FR)

(72) Inventors: Pierre BAHIN, Bobigny (FR); Helene CLOAREC, Bobigny (FR); Julien HEMON, Bobigny (FR)

(73) Assignee: VALEO VISION, Bobigny (FR)

(21) Appl. No.: 18/863,235

(22) PCT Filed: May 2, 2023
(86) PCT No.: PCT/EP2023/061542

§ 371 Date: Nov. 5, 2024

(30) Foreign Application Priority Data
May 6, 2022 (FR) FR2204335

(51) Int. Cl. F21S 41/20; F21S 41/14; F21S 43/13; F21S 43/31

(52) U.S. Cl. CPC F21S 41/2805; F21S 41/18; F21S 43/13; F21S 43/31

(57) ABSTRACT

The invention relates to a luminous device for a vehicle, including a luminous module for generating primary light rays, an exit outer lens, a decoupling relief structure, and an intermediate screen including the decoupling relief structure. The intermediate screen being arranged between the luminous module and the exit outer lens, and having a first face facing the luminous module and a second face facing the exit outer lens. The decoupling relief structure being arranged on the first face of the intermediate screen, the second face having a non-constant thickness such that the primary light rays exit therefrom in a direction identical or parallel to a direction in which they entered through the first face.

### TECHNICAL FIELD

The present invention relates to a luminous device for a vehicle. It is particularly applicable, but not limited, to automotive vehicles.

### BACKGROUND OF THE INVENTION

A luminous device known to those skilled in the art is a headlamp configured to perform an optical function. The optical function is a lighting and/or signaling function. The luminous device comprises:
at least one luminous module configured to generate light rays to form a light beam, the light beam making it possible to perform said optical function, and
a curved exit outer lens.

The style of a luminous device is an important aspect, and car manufacturers want to give their luminous devices a signature so that they are easily identifiable to the end user. To ensure that this signature is visible day and night, the exit outer lens may include a decoupling relief structure for decoupling the light rays from said light beam. This decoupling relief structure makes it possible to see the signature of the luminous device both when it is on and when it is off. This is used in particular for luminous devices with a large exterior surface area, such as luminous devices that wrap around the fender, i.e. luminous devices that extend not only over the front or rear face of the vehicle, but also over the side of the vehicle, at the part where a fender is connected to this front or rear face. It is thus possible to light up the whole of the surface area extending onto the fender.

One disadvantage of this prior art is that the curved shape of the exit outer lens with its decoupling relief structure disrupts the light beam from said at least one luminous module and consequently said optical function performed by said luminous module.

### SUMMARY OF THE INVENTION

In this context, the present invention aims to provide a luminous device that allows the aforementioned disadvantage to be overcome.

To this end, the invention proposes a luminous device for a vehicle, said luminous device comprising:
at least one luminous module configured to generate primary light rays forming a light beam,
an exit outer lens,
a decoupling relief structure,
characterized in that said luminous device further comprises:
an intermediate screen comprising said decoupling relief structure, said intermediate screen being arranged between said at least one luminous module and said exit outer lens, and having a first face facing said at least one luminous module and a second face facing said exit outer lens,
said decoupling relief structure being arranged on the first face of said intermediate screen, said intermediate screen having a non-constant thickness such that the primary light rays of said light beam exit from said second face of said intermediate screen in a direction identical or parallel to a direction in which they entered through said first face of said intermediate screen.

Thus, as will be seen in detail below, using an intermediate screen that supports the decoupling relief structure will make said screen neutral by virtue of a non-constant thickness. This is possible by modifying one of its faces, the one that does not support the decoupling relief structure, because the intermediate screen is not bound by a particular style or aerodynamics like the exit outer lens. The face that supports the decoupling relief structure is not modified, which avoids touching the decoupling relief structure itself.

According to non-limiting embodiments, said luminous device may further comprise one or more of the following additional features, implemented alone or in any technically possible combination.

According to a non-limiting embodiment, said second face of said intermediate screen comprises locally different surface orientations.

According to a non-limiting embodiment, said exit outer lens is a neutral outer lens.

According to a non-limiting embodiment, said thickness of said intermediate screen varies between 2.1 and 3.5 millimeters.

According to a non-limiting embodiment, said thickness of said intermediate screen varies gradually.

According to a non-limiting embodiment, said at least one luminous module comprises at least one primary light source configured to generate said primary light rays.

According to a non-limiting embodiment, said luminous device further comprises secondary light sources configured to generate secondary light rays, the secondary light sources being arranged such that the secondary light rays enter the intermediate screen and then propagate therein through internal reflections and exit therefrom when they encounter said decoupling relief structure.

According to a non-limiting embodiment, the primary light source(s) and/or the secondary light source(s) are semiconductor light sources.

According to a non-limiting embodiment, said decoupling relief structure comprises reliefs which are:
mini-disks, also referred to as micro-lenses, obtained by laser impact, and/or
micro-cones, and/or
micro-cone-prisms, and/or
mini-prisms, and/or
graining.

Micro or mini means that the reliefs have, in a non-limiting embodiment:
a depth of between 0.05 and 0.4 mm, preferably between 0.1 and 0.4 mm,
a distance between two reliefs of between 0.3 and 2, preferably between 0.3 and 1.6 mm, preferably between 0.8 and 1.25 mm,
a width of between 0.05 mm and 0.5 mm, preferably between 0.16 and 0.3 mm.

According to a non-limiting embodiment, said at least one luminous module is configured to perform a primary optical function which is a lighting function or a signaling function, and said intermediate screen is configured to perform a secondary optical function which is a signaling function.

According to a non-limiting embodiment, said luminous device is a headlamp or a tail light.

According to a non-limiting embodiment, said luminous device comprises a first luminous module and a second luminous module.

According to a non-limiting embodiment, the first luminous module is a lighting module and the second luminous module is a lighting module producing a beam as an alternative or in addition to the beam produced by the first luminous module.

According to a non-limiting embodiment, the lighting module(s) may be a lighting module generating at least one of the beams selected from: a cut-off beam, a high beam or an adaptive beam. An adaptive beam is a beam in which at least one shadow is cast to position it on a vehicle in front or an oncoming vehicle, so as not to dazzle the driver or the sensors thereof.

According to a non-limiting embodiment, the first luminous module is configured to perform a primary optical function, in particular a high beam, and the second luminous module is configured to perform another primary optical function, in particular a low beam.

According to a non-limiting embodiment, said exit outer lens has a non-constant thickness such that the primary light rays of said light beam exit from said outer face of said exit outer lens in a direction identical or parallel to a direction in which they entered through said inner face of said exit outer lens.

According to a non-limiting embodiment, said inner face of said exit outer lens comprises locally different surface orientations.

According to a non-limiting embodiment, said local surface orientations of said inner face of the exit outer lens are a function of the local curvature of the curve of the exit outer lens, in particular the local curvature of the curve of its outer face.

According to a non-limiting embodiment, said thickness of said outer lens varies gradually.

According to a non-limiting embodiment, the variation in the thickness of said exit outer lens is between 0.3 mm and 0.7 mm.

According to a non-limiting embodiment, the thickness of said exit outer lens varies along a longitudinal axis substantially perpendicular to the vehicle axis.

According to a non-limiting embodiment, said local surface orientations of said second face of said intermediate screen are a function of the local curvature of the curve of the intermediate screen, in particular the local curvature of the curve of said first face.

According to a non-limiting embodiment, the variation in the thickness of said intermediate screen is less than 0.7 mm.

According to a non-limiting embodiment, the thickness of the intermediate screen varies along a longitudinal axis substantially perpendicular to the vehicle axis.

According to a non-limiting embodiment, the luminous device is a luminous device that wraps around the fender.

According to a non-limiting embodiment, the thickness of said intermediate screen decreases toward the side intended to be closest to the fender of the automotive vehicle, in particular in the case of a luminous device that wraps around the fender.

According to a non-limiting embodiment, the secondary light sources and the intermediate screen are arranged so that the secondary light rays enter through an edge of the intermediate screen separating the first face from the second face.

According to a non-limiting embodiment, the first face of the intermediate screen comprises smooth portions and relief portions forming the decoupling relief structure.

According to a non-limiting embodiment, the surface area of the first face occupied by each of the relief portions is less than the surface area occupied by the smooth portions.

According to a non-limiting embodiment, the smooth portions are separated by the relief portions.

According to a non-limiting embodiment, the first face comprises alternating relief portions and smooth portions.

Also proposed is a vehicle comprising an automotive luminous device as described above.

### BRIEF DESCRIPTION OF DRAWINGS

A clearer understanding of the invention and its various applications will be gained from reading the following description and studying the accompanying figures:

FIG. 1 is an exploded schematic profile view of a luminous device for a vehicle, said luminous device comprising at least one luminous module, an exit outer lens, a decoupling relief structure, and an intermediate screen, according to a non-limiting embodiment of the invention,

FIG. 2 is an exploded perspective view of said luminous device of FIG. 1, according to a non-limiting embodiment,

FIG. 3 is a rear view of said intermediate screen of said luminous device of FIG. 2, said intermediate screen comprising said decoupling relief structure, according to a non-limiting embodiment,

FIG. 4 is a close-up view of a relief of said decoupling relief structure of said luminous device of FIGS. 1 and 2, said relief being a mini-disk, according to a non-limiting embodiment,

FIG. 5 is a schematic close-up view from the front of said exit outer lens of said luminous device of FIGS. 1 and 2, said exit outer lens being arranged in front of said intermediate screen and being neutral, according to a non-limiting embodiment,

FIG. 6 is a schematic close-up view from the front of said intermediate screen of said luminous device of FIGS. 1 and 2, said intermediate screen being arranged in front of said at least one luminous module and having a variable thickness, according to a non-limiting embodiment,

FIG. 7 is a photometric distribution diagram of a light beam emitted by said luminous device of FIGS. 1 and 2, when said exit outer lens is neutral, according to a non-limiting embodiment,

FIG. 8 is a photometric distribution diagram of a light beam emitted by a prior art luminous device, said luminous device comprising a neutral exit outer lens but no intermediate screen according to the invention,

FIG. 9 is a photometric distribution diagram of a light beam emitted by a prior art luminous device, said luminous device comprising a non-neutral exit outer lens and no intermediate screen according to the invention.

### DETAILED DESCRIPTION OF THE INVENTION

Elements that are structurally or functionally identical and that appear in several figures keep the same reference signs, unless specified otherwise.

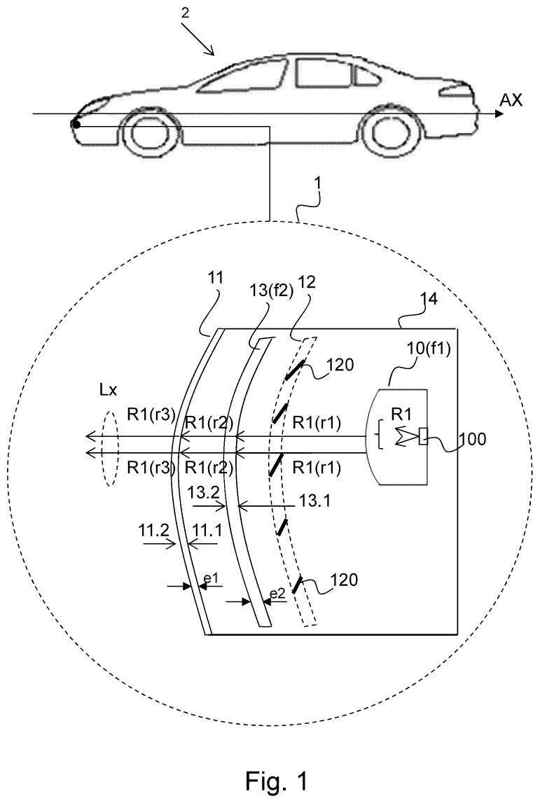

The luminous device 1 for a vehicle 2 according to the invention will now be described with reference to FIGS. 1 to 7. In a non-limiting embodiment, the vehicle 2 is an automotive vehicle. Automotive vehicle means any type of motorized vehicle. This embodiment will be considered, by way of non-limiting example, in the remainder of the description. In the remainder of the description, the vehicle 2 is thus also referred to as an automotive vehicle 2. The vehicle axis AX is shown in FIG. 1.

In a non-limiting embodiment, the luminous device 1 is a lighting and signaling device.

In a non-limiting embodiment, the luminous device 1 is a headlamp or a tail light. The luminous device 1 is thus configured to be arranged on the front face or on the rear face of the automotive vehicle 2. In a non-limiting embodiment, the luminous device 1 is a luminous device that wraps around the fender, i.e. that extends over the front face or the rear face, but also over the side of said automotive vehicle 2.

The non-limiting embodiment of the luminous device 1 arranged on the front face of the automotive vehicle 2 is given as a non-limiting example in the remainder of the description.

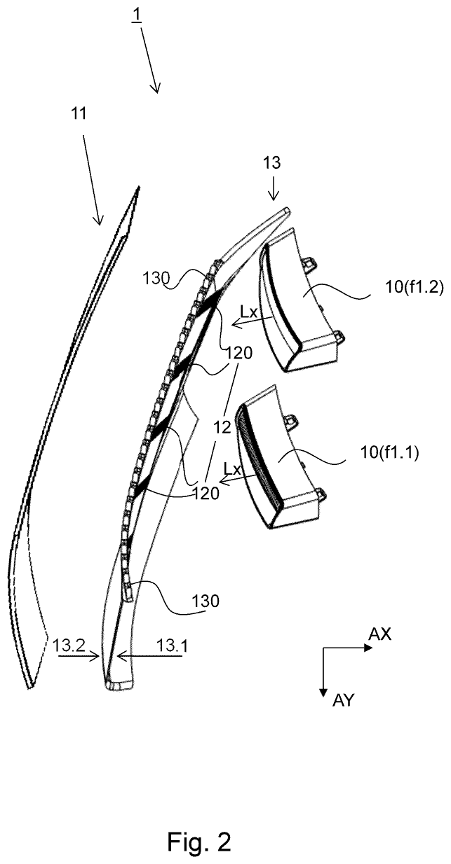

As shown in FIGS. 1 and 2, the luminous device 1 for a vehicle 2 comprises:
at least one luminous module 10, and
an exit outer lens 11, and
a decoupling relief structure 12, and
an intermediate screen 13.

As shown in FIG. 1, the luminous device 1 further comprises a housing 14 configured to accommodate in particular said at least one luminous module 10, the decoupling relief structure 12, and the intermediate screen 13.

The elements of the luminous device 1 are described in detail below.

Said at least one luminous module 10 is described in detail below.

In a non-limiting embodiment illustrated in FIG. 2, the luminous device 1 comprises two luminous modules 10. This non-limiting embodiment will be considered, by way of non-limiting example, in the remainder of the description.

Each luminous module 10 is configured to generate primary light rays R1 (shown in FIG. 1) forming a light beam Lx to perform a primary optical function f1 to which they are dedicated. The primary light rays R1 are emitted in a direction r1. The primary light rays R1 will pass through the intermediate screen 13 then the exit outer lens 11.

Each luminous module 10 comprises at least one primary light source 100 (shown in FIG. 1) configured to generate said primary light rays R1.

In a non-limiting embodiment, said at least one primary light source 100 is a semiconductor light source. In a non-limiting embodiment, said semiconductor light source forms part of a light-emitting diode. Light-emitting diode is given to mean any type of light-emitting diode, whether these are, in non-limiting examples, LEDs, OLEDs (organic LEDs), AMOLEDs (active-matrix-organic LEDs), or FOLEDs (flexible OLEDs). In another non-limiting embodiment, said at least one primary light source 100 is a halogen light or a xenon light.

Each luminous module 10 is configured to perform a primary optical function f1.

In a non-limiting embodiment, a first luminous module is a lighting module and a second luminous module is also a lighting module. In a non-limiting embodiment, the lighting modules may be a lighting module generating at least one of the beams selected from: a cut-off beam, a high beam or an adaptive beam.

Thus, in a non-limiting embodiment, a first luminous module 10 is configured to perform a first primary optical function f1.1, in this case a high beam, and a second luminous module 10 is configured to perform a second primary optical function f1.2, in this case a low beam. Thus, in this case, the luminous device 1 is configured to perform two alternative lighting functions. In a manner known to those skilled in the art, the light beam Lx which is the high beam from the first luminous module 10 is concentrated along an optical axis of the first luminous module 10 and the light beam Lx from the second luminous module 10, which is the low beam, is a cut-off beam. The two light beams Lx form an overall light beam.

The exit outer lens 11 is now described in detail below.

As shown in FIGS. 1 and 2, the exit outer lens 11 is arranged facing the intermediate screen 13 and the luminous modules 10. It serves as an outer lens for closing off the housing 14. It is arranged directly facing the intermediate screen 13 which is itself located between said exit outer lens 11 and the luminous modules 10.

In a non-limiting embodiment, the exit outer lens 11 is made of transparent plastic or glass. In a non-limiting variant embodiment, it is made of PMMA (polymethyl methacrylate).

The light beam Lx from each luminous module 10 passes through the exit outer lens 11 and exits toward the outside of the automotive vehicle 2. As shown in FIG. 1, the primary light rays R1 of a light beam Lx enter the exit outer lens 11 in a direction r2 and exit the exit outer lens 11 in a direction r3.

As shown in FIG. 1, the exit outer lens 11 has:
an inner face 11.1, also referred to as the inner skin 11.1, facing the inside of the automotive vehicle 2,
an outer face 11.2, also referred to as the outer skin 11.2, facing the outside of the automotive vehicle 2,
a thickness e1 delimited by the outer face 11.2 and the inner face 11.1.

The primary light rays R1 propagate through the thickness e1 of the exit outer lens 11.

In a non-limiting embodiment, the exit outer lens 11 is curved, that is to say its inner face 11.1 is curved and its outer face 11.2 is curved.

In a non-limiting embodiment, the thickness e1 is greater than 2 millimeters (mm). In a non-limiting variant embodiment, it is substantially equal to 2.7 mm.

In a non-limiting embodiment, the exit outer lens 11 is an exit outer lens referred to as neutral, in other words it will not affect the direction of the primary light rays RI when they pass through it and exit toward the outside. The primary light rays R1 enter through its inner face 11.1 in the direction r2 and exit through its outer face 11.2 in the direction r3.

In order to obtain a neutral exit outer lens 11, in a non-limiting embodiment, the inner face 11.1 is arranged such that the thickness e1 of the exit outer lens 11 varies. The outer face 11.2 represents a style surface of the exit outer lens 11 as well as an aerodynamic surface. It is therefore not modified. It is the inner face 11.1 that is modified to modify the thickness e1. Thus, to modify the thickness e1, the orientation of the inner face 11.1 is modified locally to obtain a neutral effect of the exit outer lens 11 on the primary light rays R1 such that the primary light rays R1 of said light beam Lx exit from said outer face 11.2 in a direction r3 identical or parallel to a direction r2 in which they entered through said inner face 11.1 of said exit outer lens 11.

Thus, the inner face 11.1 comprises locally different surface orientations. These local surface orientations are a function of the local curvature of the curve of the exit outer lens 11, in particular the local curvature of the curve of its outer face 11.2.

The modification of the thickness e1 of the exit outer lens 11 means that the inner face 11.1 and the outer face 11.2 are not parallel to one another. In a non-limiting example, the thickness e1 varies between 2.5 mm and 3.5 mm, which facilitates the design of the exit outer lens 11.

Locally modifying the orientation of the inner face 11.1 will allow the direction of the primary light rays R1 to be changed. Thus, when they enter the inner face 11.1 with a direction r2, the primary light rays R1 will be deflected locally by the local orientation of the inner face 11.1 which will modify their direction r2. Thus, when they pass through the exit outer lens 11 their direction will be different from the direction r2 in which they entered the inner face 11.1. When the primary light rays R1 are again deflected locally by the curve of the outer face 11.2, they will exit the outer face 11.2 with a direction r3 identical or parallel to the direction r2 in which they entered the inner face 11.1.

The thickness e1 varies along the largest dimension, that is along the length along a longitudinal axis AY substantially perpendicular to the vehicle axis AX when the luminous device 1 is mounted on the automotive vehicle 2. In a non-limiting embodiment, the thickness e1 of the exit outer lens 11 varies gradually, this also being referred to as monotonic variation, such that the variation in thickness e1 is not visible to the naked eye and the light beam Lx from the luminous modules 10 is not disrupted. The variation in thickness e1 is very slight, making it possible to avoid internal reflections. In a non-limiting example of an embodiment, the variation is between 0.3 and 0.7 mm.

Thus, in a non-limiting embodiment, the thickness e1 increases in the direction away from a fender of the automotive vehicle 2, in other words it decreases in the direction toward a fender of the automotive vehicle 2.

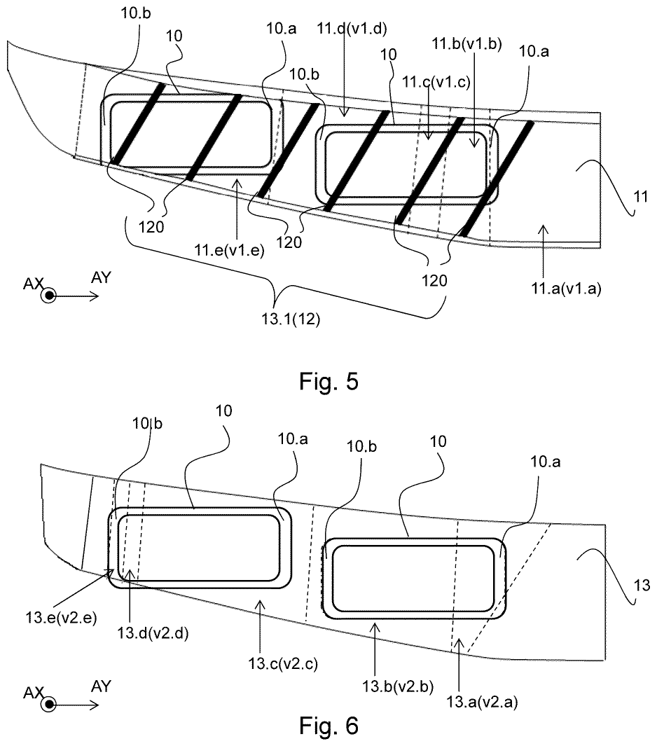

The exit outer lens 11 is shown from the front in FIG. 5, as seen by an external observer. It is positioned in front of the intermediate screen 13, which comprises the decoupling relief structure 12 on its first face 13.1, and in front of the luminous modules 10 which are located behind the intermediate screen 13. A first luminous module 10 (the one on the right) is arranged on the side toward the center of the front face of the automotive vehicle 2 and a second luminous module 10 (the one on the left) is arranged on the side toward the fender of the automotive vehicle 2.

In the non-limiting example of an embodiment illustrated in FIG. 5, the thickness e1 of the exit outer lens 11 comprises:
a value v1.a equal to 3.27 mm for a part 11.a of the exit outer lens 11 which is located facing an end 10.a of the first luminous module 10, said end 10.a being located on the side toward the center of the front face of the automotive vehicle 2,
a value v1.b equal to 3.12 mm for a part 11.b of the exit outer lens 11 adjacent to the part 11.a,
a value v1.c equal to 2.97 mm for a part 11.c of the exit outer lens 11 adjacent to the part 11.b, said part 11.c being located substantially facing the center of the first luminous module 10,
a value v1.d equal to 2.82 mm for a part 11.d of the exit outer lens 11 adjacent to the part 11.c, said part 11.d being located substantially facing the center of the first luminous module 10 and its other end 10.b and also opposite the space between the two luminous modules 10,
a value v1.e equal to 2.52 mm for a part 11.e of the exit outer lens 11 adjacent to the part 11.d, said part 11.e being located substantially facing the whole of the second luminous module 10.

In FIG. 5, the various parts 11a to 11e of the exit outer lens 11 are delimited by dotted lines.

Therefore, the primary light rays R1 which pass through the exit outer lens 11 thus made neutral will not be deflected from their direction r2 in which they entered through the exit outer lens 11. There are no disruptions to their path due to the exit outer lens 11. This reduces the influence of the curved geometry of the exit outer lens 11 on the primary light rays R1 emitted by the luminous modules 10. The primary optical function f1 performed by the luminous modules 10 is thus not affected by the curved geometry of the exit outer lens 11.

Since the neutralization of an exit outer lens 11 is known to those skilled in the art, it is not described in more detail in the description.

The intermediate screen 13 is now described in detail below.

As shown in FIGS. 1 and 2, the intermediate screen 13 is arranged between said luminous modules 10 and said exit outer lens 11.

The intermediate screen 13 is configured to perform a secondary optical function f2. In a non-limiting embodiment, the secondary optical function f2 is a signaling function. In another non-limiting embodiment, the secondary optical function f2 is an optical function which makes it possible to highlight the primary optical function f1.

In a non-limiting embodiment, the signaling function is:
a turn indicator, or
a daytime running lamp, or
a parking lamp, or
a position light, or
a stop lamp, or
a reversing lamp, or
a fog lamp, or
a side marker.

As shown in FIG. 1, the intermediate screen 13 has:
a first face 13.1 facing the luminous modules 10, also referred to as the inner face 13.1,
a second face 13.2 facing the exit outer lens, also referred to as the outer face 13.2,
a thickness e2.

The intermediate screen 13 is curved, that is to say its first face 13.1 is curved and its second face 13.2 is curved.

In a non-limiting embodiment, the intermediate screen 13 is made of transparent plastic. In a non-limiting variant embodiment, it is made of PMMA (polymethyl methacrylate). In a non-limiting embodiment, its thickness e2 is between 2 and 5 mm. This makes it easier to manufacture by injection molding.

The primary light rays R1 of the light beams Lx from each luminous module 10 enter through the first face 13.1 of the intermediate screen 13 in the direction r1 and exit through the second face 13.2 of the intermediate screen 13 in the direction r2, arriving on the exit outer lens 11.

As shown in FIG. 2, the intermediate screen 13 comprises the decoupling relief structure 12. In a non-limiting embodiment, the decoupling relief structure 12 is arranged on its first face 13.1.

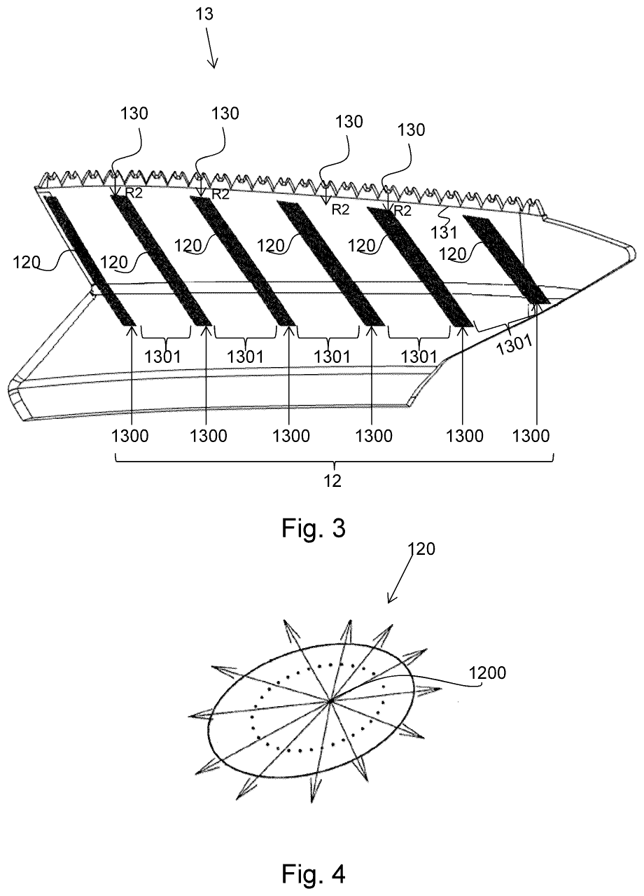

As shown in FIGS. 2 and 3, in a non-limiting embodiment, the luminous device 1 further comprises secondary light sources 130 which are semiconductor light sources. In a non-limiting embodiment, the semiconductor light sources each form part of a light-emitting diode. In a non-limiting embodiment, each semiconductor light source forms part of a light-emitting diode. Light-emitting diode is given to mean any type of light-emitting diode, whether these are, in non-limiting examples, LEDs, OLEDs (organic LEDs), AMOLEDs (active-matrix-organic LEDs), or FOLEDs (flexible OLEDs). The secondary light sources 130 are configured to be on both during the day (when the primary optical functions f1 are off) and at night (when the primary optical functions f1 are on).

As shown in FIG. 3, in a non-limiting embodiment, the secondary light sources 130 are arranged on a portion of the periphery 131 of the intermediate screen 13. The secondary light sources 130 and the intermediate screen 13 are arranged so that the secondary light rays R2 enter through an edge of the intermediate screen 13 separating the first face 13.1 from the second face 13.2.

The secondary light sources 130 generate secondary light rays R2 which propagate through the thickness e2 of the intermediate screen 13. The secondary light rays R2 propagate through the thickness e2 of the intermediate screen 13 via successive reflections on the faces 13.1 and 13.2 of the intermediate screen 13. The light coming from the secondary light sources 130 is trapped in the intermediate screen 13 thanks to the total internal reflection between the first face 13.1 and the second face 13.2 of said intermediate screen 13. The intermediate screen 13 thus acts as a light guide.

The secondary light rays R2 interact with the decoupling relief structure 12. The secondary light sources 130 are arranged such that the secondary light rays R2 enter the intermediate screen 13 and then propagate therein through internal reflections and exit therefrom when they encounter said decoupling relief structure 12.

The decoupling relief structure 12 is configured to decouple the secondary light rays R2 generated by the secondary light sources 130. The reliefs 120 of the decoupling relief structure 12 are local modifications of the relief of the face on which it is located, namely in this case the first face 13.1 of the intermediate screen 13. They make it possible to obtain several diffusion foci for the secondary light rays R2.

In a non-limiting embodiment, the first face 13.1 of the intermediate screen 13 comprises smooth portions 1301 and relief portions 1300 forming the decoupling relief structure 12. In a non-limiting embodiment, the surface area of the first face 13.1 occupied by each of the relief portions 1300 is less than the surface area occupied by the smooth portions 1301. In a non-limiting embodiment, the smooth portions 1301 are separated by the relief portions 1300. In a non-limiting embodiment, the first face 13.1 comprises alternating relief portions 1300 and smooth portions 1301.

In non-limiting embodiments, the decoupling relief structure 12 comprises a plurality of:
mini-disks, also referred to as micro-lenses, obtained by laser impact, and/or
micro-cones, and/or
micro-cone-prisms, and/or
mini-prisms, and/or
graining.

The reliefs 120 are thus mini-disks and/or micro-cones, and/or micro-cone-prisms and/or mini-prisms and/or graining. The reliefs 120 have at least partially diffusing walls. The decoupling relief structure 12 thus forms a diffusion surface. Such a diffusion surface is often described as a micro-lens surface. Micro or mini means that the reliefs 120 have, in a non-limiting embodiment:
a depth of between 0.1 and 0.4 mm,
a distance between two reliefs 120 of between 0.8 and 1.25 mm,
a width of between 0.16 mm and 0.3 mm.

FIG. 4 shows a non-limiting embodiment of a relief 120 of the decoupling relief structure 12 which is a mini-disk. The mini-disks in this case form recesses relative to the substantially smooth surface of the first face 13.1. In a non-limiting embodiment, the recesses have an apparent surface area of between 0.05 and 5 mm2. In a non-limiting embodiment, the recesses have a depth of the order of several tens of microns. The distribution of the reliefs 120 of the decoupling relief structure 12 is random, regular or follows one or more patterns. All the patterns together make it possible to have a specific signature. Thus, in the non-limiting example of FIG. 3 the signature is defined by a set of reliefs 120 forming diagonals spaced apart from one another. In non-limiting embodiments, the shape of the reliefs 120 is round or rectangular or any other type of shape. Each relief 120 forms a diffusion focus 1200. By virtue of this decoupling relief structure 12, the secondary light rays R2 which are in the vicinity of the first face 13.1 of the intermediate screen 13, referred to as grazing light rays, will diffuse in all directions (symbolized by the arrows in FIG. 4). Each relief 120 then behaves like a secondary optical source. The reliefs 120 are positioned in such a way as to minimize their impact on the primary light rays R1. Since such a decoupling relief structure 12 with mini-disks is known to those skilled in the art, it is not described in more detail here.

The decoupling relief structure 12 creates an effect of an intermediate screen 13 illuminated over part of its surface, or over its entire surface: an observer will see the entire surface of the luminous device 1 lit up. This creates an optical illusion which gives the impression of a three-dimensional luminous device 1 highlighting the style of the automotive vehicle 2. The signature of the luminous device 1 is thus always there, whether the latter is on or off (i.e. whether the primary optical functions f1 are on or off).

To prevent the curved geometry of the intermediate screen 13 from affecting the primary optical function f1 performed by the luminous modules 10 of the luminous device 1, in other words to prevent the primary light rays R1 generated by the primary light sources 100 from being deflected from their direction r1 by this intermediate screen 13, said intermediate screen 13 has a non-constant thickness e2 such that the primary light rays R1 of said light beam Lx exit from said second face 13.2 in a direction r2 identical or parallel to a direction r1 in which they entered through said first face 13.1 of said intermediate screen 13.

Compared to the neutralization of the exit outer lens 11 described above, an inverted neutralization is applied to the intermediate screen 13. The intermediate screen 13 is thus referred to as a neutral intermediate screen 13. To be specific, in this case, in order to obtain a neutral intermediate screen 13, in a non-limiting embodiment, the second face 13.2 is arranged such that the thickness e2 of the intermediate screen 13 varies. Thus, to modify the thickness e2 of the intermediate screen 13, the orientation of the second face 13.2, which is the outer face, is modified locally to obtain a neutral effect of the intermediate screen 13 on the primary light rays R1. The inner face is not modified, as in the case of the exit outer lens 11. The decoupling relief structure 12 located on the first face 13.1 of the intermediate screen 13 is thus not touched. Thus, the outer face 13.2 comprises locally different surface orientations.

The modification of the thickness e2 of the intermediate screen 13 means that the first face 13.1 and the second face 13.2 are not parallel to one another. In a non-limiting example, the thickness e2 varies between 2.1 mm and 3.5 mm, which facilitates the design of the intermediate screen 13.

Locally modifying the orientation of the second face 13.2 will allow the direction of the primary light rays R1 to be changed. Thus, when they enter the first face 13.1 with a direction r1, the primary light rays R1 will be deflected locally by the curve of the first face 13.1, but when they exit the second face 13.2, the latter will locally straighten their direction r1 such that they exit with a direction r2 identical or parallel to the direction r1 in which they entered the intermediate screen 13. These local surface orientations are a function of the local curvature of the curve of the intermediate screen 13, in particular the local curvature of the curve of the first face 13.1.

The thickness e2 varies along the largest dimension, that is along the length along the longitudinal axis AY substantially perpendicular to the vehicle axis AX when the luminous device 1 is mounted on the automotive vehicle 2. In a non-limiting embodiment, the thickness e2 varies gradually, this also being referred to as monotonic variation, such that the light beam is not disrupted. The variation in thickness e2 is very slight, making it possible to avoid internal reflections. In a non-limiting example of an embodiment, the variation is less than 0.7 mm.

Thus, in a non-limiting embodiment, the thickness e2 increases in the direction away from a fender of the automotive vehicle 2, in other words it decreases in the direction toward a fender of the automotive vehicle 2.

The intermediate screen 13 is shown in FIG. 6 from the point of view of an external observer, without the exit outer lens 11. Thus, the intermediate screen 13 is shown from the front without the decoupling relief structure 12, said screen being arranged in front of the luminous modules 10. A first luminous module 10 (the one on the right) is arranged on the side toward the center of the front face of the automotive vehicle 2 and a second luminous module 10 (the one on the left) is arranged on the side toward the fender of the automotive vehicle 2.

In the non-limiting example of an embodiment illustrated in FIG. 6, the thickness e2 comprises:
a value v2.a equal to 3.15 mm for a part 13.a of the intermediate screen 13 which is located facing an end 10.a of the first luminous module 10, said end 10.a being located on the side toward the middle of the front face of the automotive vehicle 2,
a value v2.b equal to 2.89 mm for a part 13.b of the intermediate screen 13 adjacent to the part 13.a and located substantially facing the center of the first luminous module 10 and the other end 10.b of said first luminous module 10,
a value v2.c equal to 2.53 mm for a part 13.c of the intermediate screen 13 adjacent to the part 13.b and located substantially facing the end 10.a of said second luminous module 10 and its center,
a value v2.d equal to 2.38 mm for a part 13.d of the intermediate screen 13 adjacent to the part 13.c and located facing a side of the second luminous module 10, said side being located on the side toward the end of the front face of the automotive vehicle 2,
a value v2.e equal to 2.12 mm for a part 13.e of the intermediate screen 13 adjacent to the part 13.d and located facing the other end 10.b of the second luminous module 10, said end 10.b being located on the side toward the fender of the automotive vehicle 2.

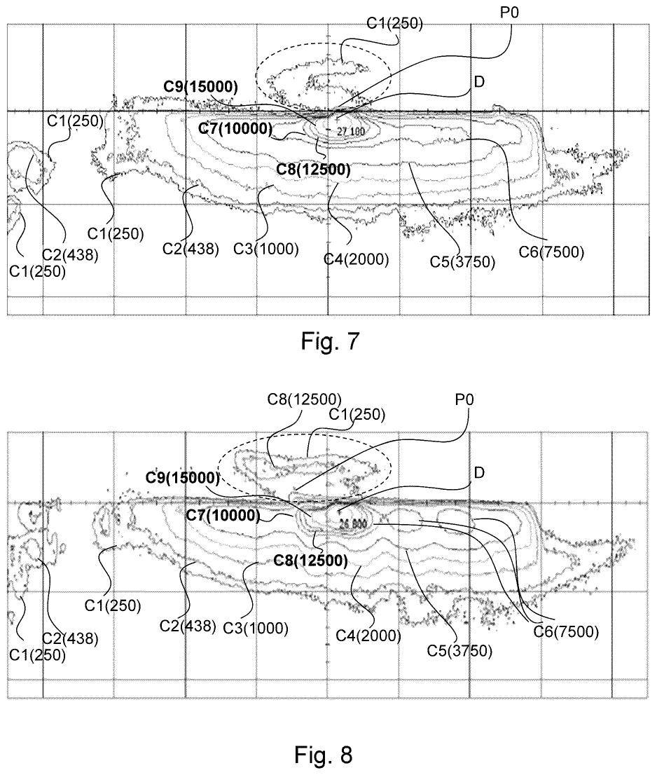

FIG. 7 shows the photometric distribution of the overall light beam from the luminous device 1 comprising the intermediate screen 13 described above and a neutral exit outer lens 11 described previously. The overall light beam is made up of the two light beams Lx from the two luminous modules 10 in the non-limiting example considered. It is thus made up of the high beam and the low beam in the non-limiting example considered. The point PO represents the cut-off of the low beam.

FIG. 7 shows photometric curves C. Each photometric curve C has a luminous intensity value shown in parentheses. The further away you go from point D shown in FIG. 7, which is the point of highest luminous intensity, the more the luminous intensity decreases. Thus, there are:
at least one curve C1 with a luminous intensity of 250 lux,
at least one curve C2 with a luminous intensity of 438 lux,
at least one curve C3 with a luminous intensity of 1000 lux,
at least one curve C4 with a luminous intensity of 2000 lux,
at least one curve C5 with a luminous intensity of 3750 lux,
at least one curve C6 with a luminous intensity of 7500 lux,
at least one curve C7 with a luminous intensity of 10000 lux,
at least one curve C8 with a luminous intensity of 12500 lux,
at least one curve C9 with a luminous intensity of 15000 lux.

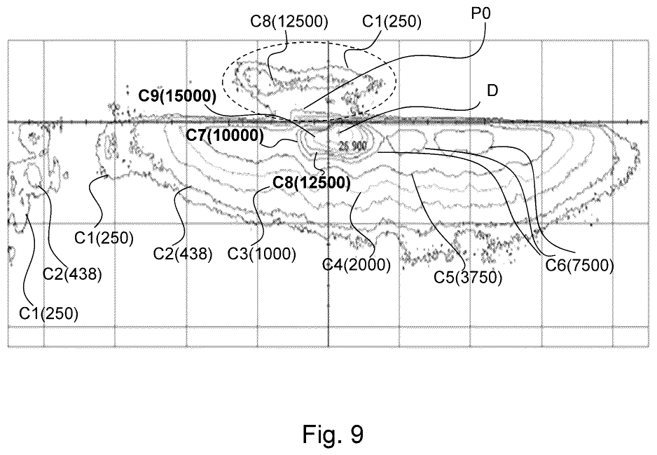

As can be seen, the photometry is less disrupted than:
when there is only a neutral exit outer lens 11 and a non-neutral intermediate screen 13 which comprises a decoupling relief structure 12 (FIG. 8),
when there is a non-neutral intermediate screen 13 which comprises a decoupling relief structure 12 and a non-neutral exit outer lens (FIG. 9).

As can be seen in FIG. 7, around and above the point PO (representing the cut-off of the low beam), there is a plume (circled in broken lines) but one without strong luminous intensity, in this case 250 lux; in FIGS. 8 and 9, on the other hand, around and above the point PO there is a more spread-out plume (circled in broken lines) with strong luminous intensities, in this case up to 12500 lux. In FIGS. 8 and 9, this plume with these high luminous intensities means that the light beam producing the low beam from the luminous device 1 does not meet regulatory requirements because it is too dazzling, whereas in FIG. 7, the light beam producing the low beam from the luminous device 1 does meet regulatory requirements.

Of course, the description of the invention is not limited to the embodiments described above and to the field described above. Thus, in another non-limiting embodiment, the reliefs 120 have at least partially reflective walls. This makes it possible to create reflective foci. In this case, the surface state of the reliefs 120 will be somewhat polished. Thus, in another non-limiting embodiment, the reliefs 120 have walls that are locally reflective and locally diffusing. This makes it possible to have “hybrid” reflective and diffusing foci. Thus, in a non-limiting embodiment, the luminous device 1 comprises several intermediate screens 13, each intermediate screen 13 possibly having its own distribution and/or type of reliefs 120. Thus, in another non-limiting embodiment, the mini-disks of the decoupling relief structure 12 are replaced by mini-prisms. Thus, in another embodiment, instead of forming part of the first face 13.1 of the intermediate screen 13, the decoupling relief structure 12 forms part of the second face 13.2 of the intermediate screen 13, in other words it is arranged on the outer face 13.2. In this case, in a non-limiting variant embodiment, the decoupling relief structure 12 has graining to perform a secondary optical function f2 which is a signature function.

The invention described thus has in particular the following advantages:
it avoids modifying the first face 13.1 of the intermediate screen 13 on which the decoupling relief structure 12 is constructed. It thus avoids having to redesign the distribution and/or the type of reliefs 120 which would have to be done each time the first face 13.1 is modified,
it avoids modifying the outer face 11.2 of the exit outer lens 11 and thus makes it possible to keep the style of the automotive vehicle 2,
arranging the decoupling relief structure 12 on the intermediate screen 13 and not on the exit outer lens 11 makes it possible to neutralize the intermediate screen 13 since the latter is not bound by a particular style. It is thus possible to adjust the orientation of one of its faces, in this case the second face 13.2 which does not bear the decoupling relief structure 12; thus, neither the curved shape of the intermediate screen 13, nor the decoupling relief structure 12 influences the direction of the primary light rays R1 generated by the luminous module(s) 10,
arranging the decoupling relief structure 12 on the intermediate screen 13 and not on the exit outer lens 11 also makes it possible to easily neutralize the exit outer lens 11 without modifying the style of said exit outer lens 11; thus, the curved shape of the exit outer lens 11 does not influence the direction of the light rays generated by the luminous module(s) 10,
it makes it possible to have one or more effective primary optical functions f1 which are not disrupted by the decoupling relief structure 12.

What is claimed is:

1. A luminous device for a vehicle, the luminous device comprising:
at least one luminous module configured to generate primary light rays forming a light beam,
an exit outer lens,
a decoupling relief structure,
an intermediate screen including the decoupling relief structure, the intermediate screen being arranged between the at least one luminous module and the exit outer lens, and having a first face facing the at least one luminous module and a second face facing the exit outer lens,
the decoupling relief structure being arranged on the first face of the intermediate screen, the intermediate screen having a non-constant thickness such that the primary light rays of the light beam exit from the second face of the intermediate screen in a direction identical or parallel to a direction in which they entered through the first face of the intermediate screen.

2. The luminous device as claimed in claim 1, wherein the second face of the intermediate screen includes locally different surface orientations.

3. The luminous device as claimed in claim 1, wherein the exit outer lens is a neutral outer lens.

4. The luminous device as claimed in claim 1, wherein the thickness of the intermediate screen varies between 2.1 and 3.5 millimeters.

5. The luminous device as claimed in claim 1, wherein the thickness of the intermediate screen varies gradually.

6. The luminous device claimed in claim 1, wherein the thickness of the intermediate screen decreases toward a side intended to be closest to a fender of the automotive vehicle.

7. The luminous device as claimed in claim 1, wherein the at least one luminous module includes at least one primary light source configured to generate the primary light rays.

8. The luminous device as claimed in claim 1, further comprising secondary light sources configured to generate secondary light rays, the secondary light sources being arranged such that the secondary light rays enter the intermediate screen and then propagate therein through internal reflections and exit therefrom when they encounter the decoupling relief structure.

9. The luminous device as claimed in claim 1, wherein the primary light source(s) and/or the secondary light sources are semiconductor light sources.

10. The luminous device as claimed in claim 1, wherein the decoupling relief structure includes reliefs which are:
mini-disks, also referred to as micro-lenses, obtained by laser impact, and/or
micro-cones, and/or
micro-cone-prisms, and/or
mini-prisms, and/or
graining.

11. The luminous device as claimed in claim 1, wherein the at least one luminous module is configured to perform a primary optical function which is a lighting function or a signaling function, and the intermediate screen is configured to perform a secondary optical function which is a signaling function.

12. The luminous device as claimed in claim 11, wherein the at least one luminous module is configured to perform a primary optical function which is a lighting function.

13. The luminous device as claimed in claim 1, wherein the lighting module is a lighting module generating at least one of the beams selected from: a cut-off beam, a high beam or an adaptive beam.

14. The luminous device as claimed claim 1, wherein the luminous device is a headlamp.

15. The luminous device as claimed in claim 1, wherein the luminous device is a tail light.
